(19) United States
(12) Patent Application Publication
(10) Pub. No.: US 2015/0344339 A1
(43) Pub. Date: Dec. 3, 2015

(54) WATER TREATMENT METHOD

(71) Applicant: TORAY INDUSTRIES, INC., Tokyo (JP)

(72) Inventors: Masahide Taniguchi, Otsu-shi, Shiga (JP); Tomohiro Maeda, Otsu-shi, Shiga (JP)

(73) Assignee: TORAY INDUSTRIES, INC., TOKYO (JP)

(21) Appl. No.: 14/655,153

(22) PCT Filed: Dec. 19, 2013
(86) PCT No.: PCT/JP2013/084044

§ 371 Date: Jun. 24, 2015

(30) Foreign Application Priority Data
Dec. 25, 2012 (JP) 2012-281055

(51) Int. Cl. C02F 9/00

(52) U.S. Cl. CPC C02F 9/00; C02F 1/52

(57) ABSTRACT

Provided is a water treatment method in which impurities such as suspended substances in raw water are efficiently removed using a separation membrane, and in particular clarified water with sufficiently high water quality is stably produced as supplied water of a reverse osmosis membrane unit using a microfiltration membrane or an ultrafiltration membrane.

The water treatment method, includes dosing a cationic coagulant to raw water a to form primary coagulated water, using the primary coagulated water as it is as final coagulated water when the zeta potential of the primary coagulated water b is less than 0 mV, or using final coagulated water obtained by dosing an anionic substance so that the zeta potential is less than 0 mV when the zeta potential of the primary coagulated water b is 0 mV or more, and treating the final coagulated water with a separation membrane of which the surface zeta potential is less than 0 mV, to obtain treated water d.

### CROSS REFERENCE TO RELATED APPLICATIONS

This is the U.S. National Phase application of PCT/JP2013/084044, filed Dec. 19, 2013, which claims priority to Japanese Patent Application No. 2012-281055, filed Dec. 25, 2012, the disclosures of these applications being incorporated herein by reference in their entireties for all purposes.

### FIELD OF THE INVENTION

The present invention relates to a water treatment method for removing impurities such as suspended substances and soluble substances in raw water using a separation membrane to obtain clarified water.

### BACKGROUND OF THE INVENTION

As a water purification technology for producing drinking water and industrial water from natural water such as river water, a technology utilizing chemistry such as coagulation-flocculation and air dissolved flotation and a technology utilizing physics such as sand filtration have been mainly popularized and developed. Sand filtration is generally classified into gravity filtration in which water is passed through a sand tank by gravity to obtain clarified water, and pressure filtration in which a pressure is applied by a pump to filter water, and is appropriately selected depending on such as the water quality of raw water and a site condition.

In recent years, in response to serious water shortage, so-called seawater desalination in which seawater is desalinated to produce drinking water and industrial water has been put to practical use. Conventionally, as the seawater desalination, evaporation technologies have been mainly put to practical use in the Middle East that has very few water resources and very rich heat resources due to petroleum. However, a reverse osmosis membrane technology having high energy efficiency is utilized. According to the reverse osmosis membrane technology, desalinated water is obtained from seawater at high efficiency even without heat source in the vicinity. Recently, the technical progress of the reverse osmosis membrane technology improves the reliability of itself and reduces the production cost. In the Middle East that has rich heat sources, many seawater desalination plants utilizing the reverse osmosis membrane technology starts to be constructed.

When seawater is directly passed through a reverse osmosis membrane, there usually cause troubles in which entry of suspended substances and organisms contained in the seawater damages the surface of the membrane, adhesion thereof to the surface of the membrane decreases membrane performance (water permeation performance, rejection performance), and a flow channel into the membrane is closed. Therefore, the water quality of seawater to be supplied to the reverse osmosis membrane needs to be noted. Accordingly, the conventional water purification technology is required even for the seawater desalination utilizing the reverse osmosis membrane technology. In general, suspended substances and microorganisms are removed by sand filtration using coagulation-flocculation and dissolved air flotation together, if necessary, to obtain clarified seawater and the clarified seawater is supplied to the reverse osmosis membrane. Recently, a microfiltration membrane with sub-micrometer fine pores or an ultrafiltration membrane having separation performance in 0.01 micrometer order has been utilized.

In order to efficiently remove impurities in natural water by sand filtration or membrane filtration, the dosage of a coagulant is effective. In particular, it is difficult to obtain clear treated water by the sand filtration, in which fine separation is more difficult than the membrane filtration with precise micro-pores, when a relatively large aggregate (floc) is not formed by dosing the coagulant, impurities leak through a filter medium typified by sands. The coagulant is classified broadly into an inorganic coagulant and an organic coagulant. The inorganic coagulant is generally used since it is more inexpensive. However, depending on the water quality of water to be treated, flocs with a sufficient size may not be formed using the inorganic coagulant. In this case, it is general to use an inorganic or organic polymer coagulant at a later stage as a so-called coagulant aid to collect fine flocs formed using the inorganic coagulant into large flocs.

For determination of kinds and dosing conditions of the coagulants, the water to be treated is placed in a beaker as a sample, and the coagulation state is observed with stirring. Ajar tester of finding a condition of the best coagulation state or a cylinder tester of comparing a sedimentation rate in a test tube is generally used. However, when the water to be treated is natural water, the water quality largely varies in a short time depending on variation of environment caused by rain, wind, and ocean current, for example. Therefore, the coagulation condition determined by the testers does not always match the water quality of raw water to be treated actually. For this reason, it is difficult to determine an appropriate concentration of coagulant to be dosed, and flexibly vary the coagulation condition. In treatment of raw water to which the coagulant is dosed with a separation membrane, when the raw water contains many impurities and the amount of dosed coagulant is insufficient, sufficient flocs are not formed. As a result, the separation membrane cannot exert sufficient rejection performance, and the water quality of treated water is deteriorated. Further, suspended particles penetrate into micro-pores of the separation membrane, and the filtration performance of the separation membrane is very likely to be deteriorated. In contrast, when the coagulant is excessively dosed, the coagulant leaks, to deteriorate the water quality of treated water. In addition, depending on the kind of the coagulant, adsorption of coagulated flocs on the separation membrane is promoted to pollute the separation membrane and decrease the filtration performance.

In order to solve the problems, as a method for controlling the coagulation condition depending on raw water, coagulated water, an increase in pressure of the separation membrane, and the like, many controlling methods are proposed. The control methods include a method for controlling the dosing concentration of a coagulant such as aluminum sulfate and polyaluminum chloride to optimize the particle diameter of flocs depending on the turbidity of raw water (Patent Document 1), a method for controlling the dosing concentration of a coagulant depending on a measurement value of ultraviolet absorbance (Patent Document 2), a method for controlling the dosing concentration of a coagulant depending on a filtration pressure-increasing rate through a separation membrane after coagulation (Patent Document 3), a method for controlling the dosing amount of a coagulant depending on the chromaticity and turbidity of raw water (Patent Document 11), a method depending on a phosphorous concentration (Patent Document 5), a method depending on the concentration of an organic substance (Patent Document 6), a method for controlling the coagulation condition depending on a cationic coagulant so that the zeta potential of coagulated flocs is less than 0 mV (Patent Document 7), a method in which the concentration of residual ozone is measured with injection of ozone and the dosing amount of a coagulant is increased (Patent Document 8), and a method in which dissolved organic carbon and chemical oxygen demand are measured and the dosage of a coagulant is determined (Patent Document 9). In particular, a relation between coagulated flocs and the electric charge of a separation membrane, shown in Patent Document 9, promotes the adhesion of the coagulant to the membrane. This shows an electrochemical property. Focus on the zeta potential as an index of preventing a decrease in the performance of the separation membrane due to the adhesion of the coagulant to the surface of the membrane is very effective.

In order to reduce accumulation of impurities on the separation membrane regardless of the turbidity of raw water, the following methods are also proposed. The methods include a method for reducing the dosing concentration of a coagulant with the accumulation of aggregates on the surface of a separation membrane (Patent Document 12), a method in which the dosage of a coagulant is stopped in a constant time after initiation of membrane filtration (Patent Document 6), a method in which an dosing condition of a coagulant is varied depending on a filtration pressure (Patent Document 14), a method in which large coagulated flocs are sedimented and separated in advance to reduce a load on a separation membrane (Patent Document 15), a method for measuring the concentration of a coagulant in treated water and controlling the dosing concentration of the coagulant to prevent deterioration in the water quality of treated water due to leakage of the coagulant to filtration treated water during dosage of excessive coagulant (Patent Document 14), and a method of determining a coagulation treatment condition again depending on the presence or absence of coagulation treatment of raw water of coagulated flocs (Patent Document 15). The known examples (Patent Documents 2 to 15) describe use of any of ferric chloride, aluminum sulfate, polyaluminum chloride, and a cationic polymer coagulant as a cationic coagulant.

However, in the method for controlling the dosing concentration of a coagulant depending on the water quality of raw water and the like, the cost for equipment increases, a relationship between the water quality of raw water and the dosing concentration is not easily quantitated, and complicated control is needed. In any methods, it is very difficult to deal with large-scale variation in the water quality of raw water without time lag when there is, for example, a shower, and the pollution of the separation membrane is not easily prevented.

### PATENT DOCUMENTS

Patent Document 1: JP 11-57739 A

Patent Document 2: JP 8-117747 A

Patent Document 3: JP 10-15307 A

Patent Document 4: JP 2004-330034 A

Patent Document 5: JP 2005-125152 A

Patent Document 6: JP 2008-68200 A

Patent Document 7: JP 2009-248028 A

Patent Document 8: JP 2009-255062 A

Patent Document 9: JP 2010-12362 A

Patent Document 10: JP 2001-70758 A

Patent Document 11: JP 2002-336871 A

Patent Document 12: JP 2008-168199 A

Patent Document 13: JP 2009-226285 A

Patent Document 14: JP 2010-201335 A

Patent Document 15: JP 2011-161304 A

### SUMMARY OF THE INVENTION

The present invention provides a water treatment method in which impurities such as suspended substances in raw water are efficiently removed using a separation membrane, and in particular clarified water with sufficiently high water quality is stably produced as supplied water of a reverse osmosis membrane unit using a microfiltration membrane or an ultrafiltration membrane.

In order to solve the problems, the present invention includes the following aspect.

A water treatment method includes

dosing a cationic coagulant to raw water to form primary coagulated water,

using the primary coagulated water as it is as final coagulated water when the zeta potential of the primary coagulated water is less than 0 mV, or using final coagulated water obtained by dosing an anionic substance so that the zeta potential is less than 0 my when the zeta potential of the primary coagulated water is 0 mV or more, and

treating the final coagulated water with a separation membrane of which the surface zeta potential is less than 0 mV, to obtain treated water.

As a preferred aspect, the present invention includes the following aspects.

(2) The water treatment method, wherein a concentration Cop1 of a cationic coagulant to be dosed in the primary coagulated water is set to a value that is larger than Cmin and smaller than Cmax, Cmin and Cmax which are each determined and defined as follows:
Cmin: Concentration of a cationic coagulant in the primary coagulated water capable of obtaining the maximum coagulation effect when the water quality index of raw water is the lowest; and
Cmax: Concentration of a cationic coagulant in the primary coagulated water capable of obtaining the maximum coagulation effect when the water quality index of raw water is the highest.
(3) The water treatment method, wherein the water quality index of raw water is at least one selected from the group consisting of a turbidity, a fine particle concentration, a total suspended solid (TSS) concentration, a total organic carbon (TOC) concentration, a dissolved organic carbon (DOC) concentration, a chemical oxygen demand (COD), a biological oxygen demand (BOD), and a ultraviolet ray adsorption (UVA) amount.
(4) The water treatment method according to any of the aspects, wherein an dosing concentration Cop2 of an anionic substance
is determined in advance so that the zeta potential is to be less than 0 mV by the dosing to water in which the cationic coagulant is dosed to pure water so that the concentration is to be a difference (Cmax−Cmin), and the anionic substance is dosed to the primary coagulated water so that the concentration in the primary coagulated water is Cop2.
(5) The water treatment method according to any of the aspects, wherein the cationic coagulant is an inorganic coagulant and the anionic substance is an organic coagulant.
(6) The water treatment method according to any of the aspects, wherein the water treated with the separation membrane is further desalinated with a semipermeable membrane having a surface zeta potential less than 0 mV.

According to a water treatment method of an embodiment of the present invention, when impurities in water such as seawater and river water are coagulated, separated, and removed with a separation membrane, the performance of the separation membrane can be maintained and clarified water with high quality can be stably obtained.

In particular, even when the water quality of raw water varies, clarified water with high water quality can be stably obtained at low cost by properly adjusting the dosing concentration of a cationic coagulant and an anionic substance.

### BRIEF DESCRIPTION OF THE DRAWINGS

FIG. 1 is a flow diagram exhibiting an example of a water treatment device using a water treatment method of the present invention.

FIG. 2 is a flow diagram exhibiting an example of a desalinated water treatment device using the water treatment method of the present invention.

### DETAILED DESCRIPTION OF EMBODIMENTS OF THE INVENTION

Hereinafter, embodiments of the present invention will be described with reference to the drawings, but the present invention is not limited to the embodiments.

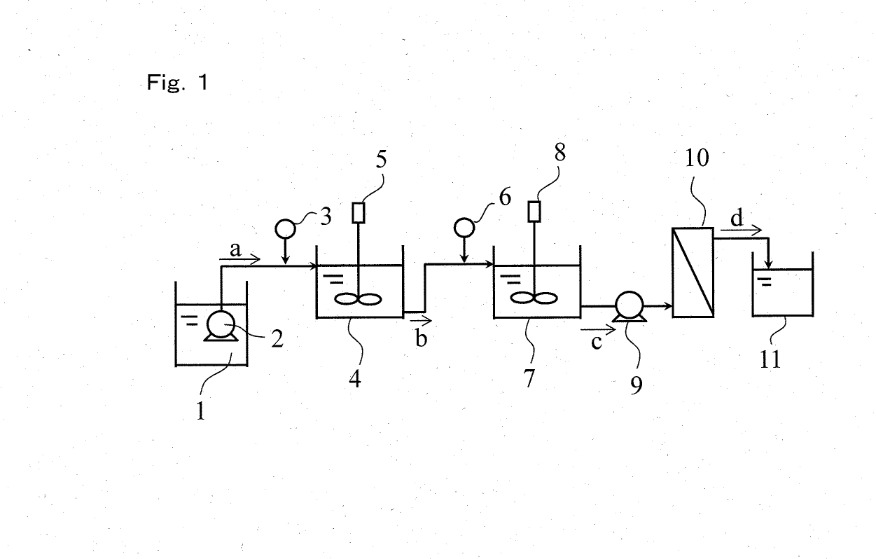

FIG. 1 is a flow diagram exhibiting an example of a water treatment device to which the present invention can be applied.

In FIG. 1, raw water a is stored in a raw water tank 1, and taken by an intake pump 2, a cationic coagulant having positive charges is dosed by a cationic coagulant dosing unit 3, and flocs are formed and grown by a first stirrer 5 in a first mixing tank 4 to obtain primary coagulated water b. Next, when the zeta potential of the primary coagulated water b is 0 mV or more, an anionic substance having negative charges is dosed by an anionic substance dosing unit 6, the cationic coagulant is neutralized by a second stirrer 8 in a second mixing tank 7, and the coagulated flocs are further grown to obtain final coagulated water c. In contrast, when the zeta potential of the primary coagulated water b is less than 0 mV, the primary coagulated water b is used as it is as final coagulated water c without dosing an anionic substance. Herein, when the cationic coagulant is excessively dosed at the former stage, the anionic substance acts for neutralization of the cationic coagulant. In contrast, when the cationic coagulant is not excessive, the anionic substance acts on a cationically charged portion of the coagulated flocs totally having anionic charges that is formed at the former stage, to grow the coagulated flocs.

The final coagulated water c that contains impurities forming the coagulated flocs treated as described above is transferred by a pressure pump 9 to a separation membrane unit 10 having a surface zeta potential of less than 0 mV, that is, using a porous film having negatively charged surface charges, water permeated through the separation membrane is stored in a filtrate tank 11 as treated water d that is clarified.

Herein, the zeta potential represents an electric potential over an interface between a solid and a liquid, and represents a surface charge of colloidal particles in water. In general, since colloidal particles contained in natural water are negatively charged, the particles electrically repel and are dispersed in water. The coagulant neutralizes the charges to reduce the repulsive force, followed by formation of aggregation, that is, coagulation.

The zeta ζ_{c} potential of the primary coagulated water can be calculated from a traveling rate of the coagulated flocs by electrophoresis. In measurement for the calculation, a surface potential measurement device such as an electrophoresis light scattering device (ELS-8000: manufactured by OTSUKA ELECTRONICS Co., LTD.) can be used. The zeta potential can be also determined by calculating the zeta potential of the coagulated flocs from a streaming potential E_{c} generated between electrodes during flowing the coagulated water by a constant pressure difference using Helmholtz-Smoluchowski equation (see the following equation (1)).

ζ_{c}=E_{c}/ΔP×(η_{c}·λ_{c})/∈_{c}·∈₀ (1)

E_{c}: streaming potential (mV) generated between electrodes by flowing coagulated water at constant pressure difference
ΔP: Pressure difference (mBar) between electrodes
η_{c}: viscosity (Pa·s) of coagulated water
λ_{c}: electric conductivity (S/cm) of coagulated water
∈_{c}: dielectric constant (−) of coagulated water
∈₀: dielectric constant in vacuum (=8.854×10⁻¹²) (F/m)
η_{c} may be calculated from the temperature of the coagulated water, or measured by a commercially available viscometer, for example, a viscometer SV-10 manufactured by A&D Company, Limited.

In the present invention, the cationic coagulant is not particularly restricted as long as it has positive charges and is likely to selectively coagulate negatively charged substances. An inorganic coagulant that is inexpensive and has excellent coagulation force of fine particles, an organic polymer coagulant that is expensive but has large coagulation force due to a large number of functional groups, or the like can be used. Preferred specific examples of the inorganic coagulant may include ferric chloride, (poly)ferric sulfate, aluminum sulfate, and (poly) aluminum chloride. In particular, an iron-based coagulant, and particularly inexpensive ferric chloride are preferably applied in use for applications of drinking water. This is because the concentration of aluminum may be a problem. Typical examples of polymer coagulant may include an aniline derivative, polyethyleneimine, polyamine, polyamide, and cationically modified polyacrylamide.

In contrast, the anionic substance is not particularly restricted as long as it has negative charges. The anionic substance can be used in the present invention as long as it is negatively charged in water. Examples thereof may include a halogen, a salt with an acid having a sulfate ion, a thiosulfate ion, or a hexacyanoferrate ion as a counter ion, a salt of a weak base such as an ammonium ion with the acid having the counter ion describe above, an anionic surfactant such as a dodecyl sulfate salt and a dodecyl sulfonate salt, and an anionic polymer coagulant. Examples of the anionic polymer coagulant may include alginic acid as a natural organic polymer, and representative examples of an organic polymer coagulant may include polyacrylamide. In particular, alginic acid and polyacrylamide are highly preferred as the anionic substance since they are likely to selectively coagulate a positively charged substance.

The separation membrane may have a negatively charged surface charge in the same pH, temperature, ionic strength as those of the final coagulated water, that is, a surface zeta potential of less than 0 mV. Herein, the surface zeta potential ζₘ of the separation membrane can be measured with a surface potential measurement device such as an electrophoresis light scattering device (ELS-8000: manufactured by OTSUKA ELECTRONICS Co., LTD.) The surface zeta potential can be also determined by calculating the zeta potential ζₘ of the membrane from a streaming potential Eₘ generated by filtration and/or backwashing due to transmembrane pressure difference using Helmholtz-Smoluchowski equation (see the following equation (2)).

ζₘ=Eₘ/ΔP×(ηₘ·λₘ)/∈ₘ·∈₀ (2)

Eₘ: streaming potential (mV) generated between electrodes by filtration and/or backwashing due to transmembrane pressure difference
ΔPₘ: transmembrane pressure difference (mBar)
ηₘ: viscosity (Pa·s) of filtered or backwashed water
λₘ: electric conductivity (S/cm) of filtered or backwashed water ∈ₘ: dielectric constant (−) of filtered or backwashed water ∈₀: dielectric constant in vacuum=8.854×10⁻¹² (F/m)

As described in JP 2005-351707 A, the zeta potential of the membrane in an on-line membrane module can be calculated using the equation (2) from a transmembrane pressure difference (ΔPₘ) determined by a transmembrane pressure difference meter of a membrane filtration device provided in the membrane module, a streaming potential (Eₘ) determined by the transmembrane pressure difference meter by filtration or backwashing at this transmembrane pressure difference (ΔPₘ), a conductance (λₘ) determined by a conductance meter of filtered or backwashed water, and a viscosity (ηₘ) of a solution determined from the temperature of filtered or backwashed water determined by a thermometer. The transmembrane pressure difference (ΔPₘ) and the streaming potential (Eₘ) can be measured during filtration or backwashing. However, they cannot be measured when water is not transferred between the membranes during immersion washing with a chemical or the like. In this case, they can be measured during reinitiation of filtration of raw water or backwashing with filtrate.

Specific examples of the separation membrane may include separation membranes formed from polyamide, polyethylene, polypropylene, polyvinylidene fluoride, polytetrafluoroethylene, polysulfone, and polyethersulfone, and surface-modified membranes that are negatively charged by surface modification of these membranes. The kind of the separation membrane is preferably a microfiltration membrane, an ultrafiltration membrane, or a nanofiltration membrane. The nanofiltration membrane is preferably a membrane having a larger micropore diameter. Specifically, it is preferable that coagulated flocs be separated through a separation membrane having micropores of 1 μm or less and 1 nm or more. The shape of the separation membrane is not particularly restricted, and membranes having various shapes such as a hollow fiber membrane, a capillary membrane, a flat membrane, and a spiral wounded membrane may be applied.

In the water treatment method of the present invention, a method of determining the dosing amount of the cationic coagulant is not particularly restricted. In order to effectively apply the present invention, it is not necessary that the water quality be frequently measured or a laboratory test for evaluating coagulation property be carried out in consideration of the variation in water quality of raw water, and it is preferable that the concentration of coagulant in primary coagulated water be generally made constant. Specifically, raw water is sampled a plurality times in advance for a predetermined period of time, the water quality indexes thereof are calculated. The “predetermined period of time” is not particularly limited. The water quality index can be determined on the basis of data in a year, or in every season. The water quality index will be described below. Of raw water, to each of raw water that has maximum water quality index and raw water that has minimum water quality index, the cationic coagulant is dosed, and a coagulation test of evaluating the coagulation effect is carried out. Herein, the coagulation test is not particularly limited. In the coagulation test, raw water and the cationic coagulant are placed in a plurality of beakers under the same stirring condition at different concentration of the cationic coagulant in the raw water, and raw water having the best coagulation property is considered as raw water having the highest coagulation effect. Thus, the coagulation effect can be evaluated by a method that is referred to so-called “jar test.” Coagulation property can be judged to be good or bad by visually observing a supernatant in a certain period of time after the coagulation test or evaluating the water quality index. The concentration Cmax of the cationic dosed coagulant is a concentration capable of obtaining the maximum coagulation effect in raw water having the highest water quality index and the concentration Cmin of the cationic dosed coagulant is a concentration capable of obtaining the maximum coagulation effect in raw water having the lowest water quality index. At this time, the zeta potential ζₘₐₓ at which the cationic coagulant is dosed to raw water having the highest water quality index so as to have the concentration Cmax, and the zeta potential ζₘᵢₙ at which the cationic coagulant is dosed to raw water having the lowest water quality index so as to have the concentration Cmin are each measured.

When both the zeta potentials ζₘₐₓ and ζₘᵢₙ determined in the measurement are less than 0 mV, the cationic coagulant is constantly dosed to raw water a so that the dosing concentration Cop1 of the cationic coagulant is substantially equal to Cmax, and the obtained primary coagulated water is used as final coagulated water. Therefore, dosage of the anionic substance, as described below, is not carried out.

In contrast, when at least one of the zeta potentials ζₘₐₓ and ζₘᵢₙ is 0 mV or more, the concentration Cop1 of the cationic coagulant is set to a value that is larger than Cmin and smaller than Cmax. In this case, the cationic coagulant is dosed o raw water a so as to have the concentration Cop1 of the cationic coagulant, causing coagulation, and primary coagulated water is obtained. Since the primary coagulated water has a zeta potential of 0 mV or more, the dosage of the anionic substance is then necessary.

Subsequently, a method of determining the concentration Cop2 of the anionic substance that is dosed to the primary coagulated water will be described. Water in which the cationic coagulant is dosed to pure water so that the coagulant concentration is a difference (Cmax−Cmin) between the concentrations Cmax and Cmin is prepared in advance. It is preferable that the concentration of the anionic substance at which the zeta potential in the water is less than 0 mV be determined as the concentration Cop2 of the anionic substance that is dosed to the primary coagulated water. Even when a maximum amount of the cationic coagulant is dosed (that is, at the dosing concentration Cmax), the amount of the cationic coagulant in the final coagulated water c, that is, in supplied water to the separation membrane, is excessive by dosing the anionic substance at the dosing concentration Cop2, followed by coagulation, and as a result, coagulated flocs to be filtrated through the separation membrane are not positively charged. Thus, absorption of the coagulated flocs on a separation membrane having charges of less than 0 mV can be prevented. According to this suitable treatment method, the amount of the anionic substance to be dosed at the latter stage is larger. However, impurities such as organic substances contained in natural water have complex structures, and if the anionic substance is a polymer, the anionic substance comes into contact with the impurities to cause coagulation easily, the impurities are unlikely to leak the separation membrane. An anionic polymeric substance that is not coagulated is unlikely to penetrate into the micropores of the separation membrane due to the negative charges of the separation membrane, leakage to treated water can be prevented.

When raw water is general natural water, the zeta potential of the raw water is less than 0 mV in many cases. However, when raw water is industrial waste water, the raw water contains various impurities. Therefore, the impurities may have positive charges, that is, the zeta potential of the raw water may be 0 mV or more. When raw water that constantly has a zeta potential of 0 mV or more is treated, the dosing concentration of the cationic coagulant is 0, various amounts of the anionic substance are dosed, and the dosing concentration capable of exhibiting the largest effect are measured. Among the dosing concentration, the largest dosing concentration is found. It is preferable that the largest dosing concentration be determined as Cop2.

This determining method can be carried out on the basis of previous raw water samples. Therefore, Cmax, Cmin, Cop1, and Cop2 can be determined on the basis of data in a certain period, for example, in a year or in every season.

In measurement and evaluation of the water quality of raw water, preferred evaluation items of the water quality index include a turbidity, a fine particle concentration, a total suspended solid (TSS) concentration, a total organic carbon (TOC) concentration, a dissolved organic carbon (DOC) concentration, a chemical oxygen demand (COD), a biological oxygen demand (BOD), and a ultraviolet ray adsorption (UVA) amount. However, the water quality index is not limited to these. Preferable examples of the evaluation items may include SUVA (ratio of TOC and UVA) as the water quality index that presumes a ratio of humic substances having high aromaticity that is a component likely to be coagulated in organic substances described in Tanbo and Kamei (JWWA Journal 62(9) 28-40 (1994), Water Research 12(11) 931-950 (1978)). The above-described water quality index can be calculated by a known method.

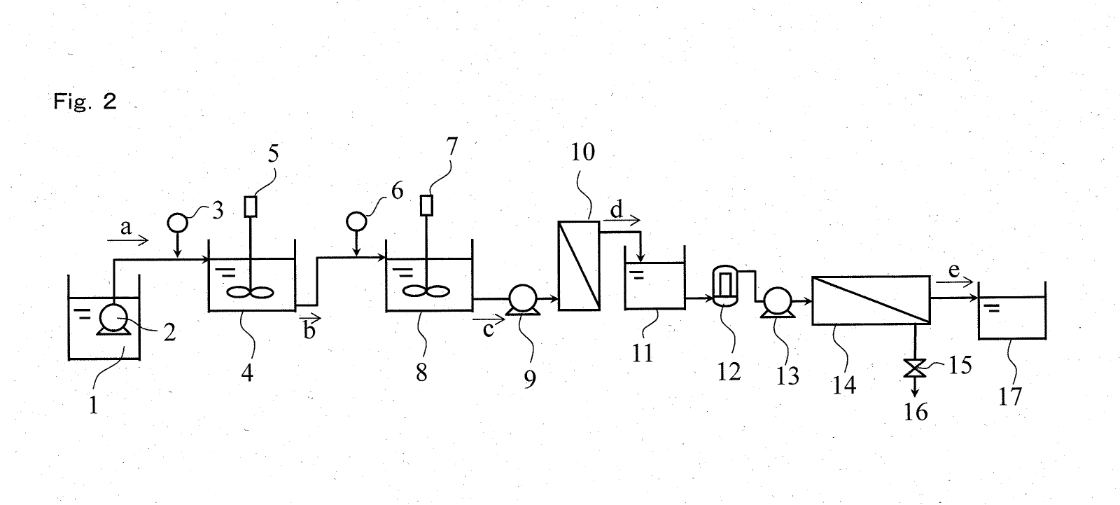

The obtained treated water is further treated with a high-precision membrane to obtain water having high purity. Recently, particularly in fields of seawater desalination, reuse of sewage, and advanced water purification treatment, a technology in which a coagulant is dosed to raw water, followed by treatment with a microfiltration membrane or an ultrafiltration membrane, to obtain clarified water, the clarified water is desalinated with a semipermeable membrane, and the obtained water is utilized as drinking water or industrial water is put to practical use throughout the world. FIG. 2 shows a flow of exemplary process thereof. Herein, the treated water d obtained by the water treatment process shown in FIG. 1 is passed through a safety filter 12, and a pressure is increased by a high-pressure pump 13 to obtain desalinated water e by a semipermeable membrane unit 14.

When the water treatment method of the present invention is applied, a separation membrane having a surface zeta potential of less than 0 mV can prevent the cationic coagulant from leaking through the separation membrane unit 10, but the anionic substance may leak. Therefore, it is preferable that the zeta potential of the semipermeable membrane constituting the semipermeable membrane unit 14 be less than 0 mV. Accordingly, even when the coagulant leaks through the semipermeable membrane 14 and abnormalities occur in the separation membrane 10 and thus the separation membrane 10 is damaged to leak coagulated flocs, the coagulant can be prevented from being adsorbed on the semipermeable membrane. Therefore, this is very preferred. The permeated water treated with the semipermeable membrane unit 14 is transferred to a desalinated water tank, and the concentrate is passed through a concentrate flow rate adjusting valve 15 and a concentrate line 16 and discharged.

Since the zeta potentials of the separation membrane and the semipermeable membrane vary depending on the temperature of water, the pH, and the ionic strength, the zeta potentials are measured in an environment where water to be treated to which the membranes is exposed (final coagulated water c and treated water d), the temperature, the pH, and the ionic strength each are the same conditions.

### EXAMPLES

Seawater was sampled as raw water every week for 6 months, and TOC was measured. The maximum of TOC was 5.5 mg/L and the minimum of TOC is 1.2 mg/L. One (1) L of seawater having a TOC of 5.5 mg/L was placed in a beaker. Jar test was carried out by dosing ferric chloride as a cationic coagulant with stirring under a condition of a rotation speed of 150 rpm and a stirring time of 3 minutes. The UV (254 nm) absorption of the supernatant was measured and evaluated. The concentration of the coagulant having the highest coagulation effect Cmax was 14.5 mg/L, and the zeta potential ζmax was −4.5 mV. Similarly, jar test was carried out using seawater having TOC of 1.2 mg/L. The concentration of the coagulant having the highest coagulation effect Cmin was 2.9 mg/L, and the zeta potential ζmin was −5.4 mV.

As the anionic substance, “Takifloc” A-112T available from TAKI CHEMICAL CO., LTD., was used. Water was obtained by dosing ferric chloride to pure water so that a difference between the concentrations Cmax and Cmin, that is, (Cmax−Cmin) was 11.6 mg/L. The dosing concentration of the anionic substance to the water at which the zeta potential was less than 0 mV was measured. The concentration Cop2 was 5.0 mg/L.

### Example 1

A desalinated water generator of a configuration shown in FIG. 2 was used to generate water. Specifically, for a separation membrane unit 10, a pressurized hollow fiber membrane module (HFU-2008) having a membrane area of 11.5 m² and using a hollow fiber UF membrane (surface zeta potential: −10±1 mV) that was made of polyvinylidene fluoride and had a molecular weight cutoff of 150,000 Da, available from TORAY INDUSTRIES, INC., was used. A pressure pump 9 was operated. Seawater (about 20° C.) having TOC of 1.2 mg/L to 5.5 mg/L and a salt concentration of 3.5% by weight was subjected to dead end filtration at a filtration flux of 3 m/d. The separation membrane unit 10 is provided with a backwashing pump which supplies filtrate from a secondary side to a primary side of the membrane, and a compressor of supplying air from a lower portion of the separation membrane unit 10 to the primary side of the membrane, which is not shown in FIG. 2. The separation membrane unit 10 was continuously operated for 30 minutes, and the filtration was stopped once. The separation membrane unit 10 was subjected to physical washing which performs counter-pressure washing at backwashing flux of 3.3 m/d and air washing which supplies air at 14 L/min from the lower portion of the separation membrane unit 10 at the same time for 1 minute. After then, dirt in the separation membrane unit 10 was drained with water, and this cycle was repeated for usual filtration.

In a semipermeable membrane unit 14, a reverse osmosis membrane element (TM810C) available from TORAY INDUSTRIES, INC., was used. The semipermeable membrane unit 14 was operated at a RO supply flow rate of 23.3 m³/d and a permeability flow rate of 2.8 m³/d (recovery rate: 12%). While the separation membrane unit 10 was subjected to the physical washing, the operation was continuously carried out using filtrate stored in a filtrate tank 11 in the semipermeable membrane unit 14.

As a result, the filtration differential pressure of the separation membrane unit 10 transited within a range of 55 kPa to 100 kPa, and the operation was stably carried out. The operation was stably carried out for 3 months at an operation pressure of the semipermeable membrane unit 14 of 5.0 to 5.5 MPa.

At that time, the coagulant was constantly dosed by a cationic coagulant dosing unit 3 at the concentration Cop1 determined from the dosing concentrations Cmax and Cmin obtained by the jar test so that the concentration of ferric chloride in a coagulation tank was about 8.7 mg/L. The zeta potential of the resulting primary coagulated water was +5.5 mV (average). After then, the anionic substance was dosed by an anionic substance dosing unit 6 so that the concentration was 5.0 mg/L. The zeta potential of the final coagulated water was −6.9 mV (average). The surface zeta potential of the separation membrane unit 10 was −10 mV. The surface zeta potential of the semipermeable membrane unit 14 was −30 mV.

### Example 2

An operation was carried out under the same condition as in Example 1 except that the dosing concentration Cop1 of ferric chloride was adjusted to Cmin=2.9 mg/L and an anionic substance was not dosed to the obtained primary coagulated water. The zeta potential of the final coagulated water was −1.2 mV (average). As a result, the filtration differential pressure of the separation membrane unit 10 transited within a range of 55 kPa to 120 kPa, and the operation was comparatively stably carried out. An uncoagulated component due to insufficient dosage of a coagulant passed through the separation membrane unit 10, the operation was stably carried out for 2 months at an operation pressure of the semipermeable membrane unit 14 of 5.0 to 5.5 MPa. After 1 month, the operation pressure increased to 6.5 MPa, and development of fouling in the semipermeable membrane unit 14 was suggested.

### Comparative Example 1

An operation was carried out under the same condition as in Example 1 except that an anionic substance was not dosed to primary coagulated water. The zeta potential of the primary coagulated water as final coagulated water was +5.5 mV (average). As a result, the operation was stably carried out for 3 months at an operation pressure of the semipermeable membrane unit 14 of 5.0 to 5.5 MPa. However, the filtration differential pressure of the separation membrane unit 10 exceeded 150 kPa after 1 month as compared with Example 1, and continued continuous operation was made difficult.

### Comparative Example 2

An operation was carried out under the same condition as in Example 1 except that an anionic substance was dosed at a concentration of 1.0 mg/L to primary coagulated water and the zeta potential of final coagulated water was +4.2 mV (average). As a result, the operation was stably carried out for 3 months at an operation pressure of the semipermeable membrane unit 14 of 5.0 to 5.5 MPa. However, the filtration differential pressure of the separation membrane unit 10 exceeded 180 kPa after 2 months as compared with Example 1, and continued continuous operation was made difficult.

### Comparative Example 3

An operation was carried out under the same condition as in Example 1 except that a cationic coagulant and an anionic substance were not dosed to raw water. The zeta potential of final coagulated water (i.e., raw water) was −11.7 mV (average). As a result, the filtration differential pressure of the separation membrane unit 10 transited within a range of 55 kPa to 135 kPa, and the operation was comparatively stably carried out. The operation pressure of the semipermeable membrane unit 14 was first 5.0 to 5.5 MPa, and started to increase after 1 month. After 2 months, continued continuous operation was made difficult.

### DESCRIPTION OF REFERENCE SIGNS

1: Raw water tank
2: Intake pump
3: Cationic coagulant dosing unit
4: First mixing tank
5: First stirrer
6: Anionic substance dosing unit
7: Second mixing tank
8: Second stirrer
9: Pressure pump
10: Separation membrane unit
11: Filtrate tank
12: Safety filter
13: High-pressure pump
14: Semipermeable membrane unit
15: Concentrate flow rate adjusting valve
16: Concentrate line
17: Desalinated water tank
a: Raw water
b: Primary coagulated water
c: Final coagulated water
d: Treated water
e: Desalinated water

1. A water treatment method comprising
dosing a cationic coagulant to raw water to obtain primary coagulated water,
using the primary coagulated water as it is as final coagulated water when the zeta potential of the primary coagulated water is less than 0 mV, or using final coagulated water obtained by dosing an anionic substance so that the zeta potential is less than 0 mV when the zeta potential of the primary coagulated water is 0 mV or more, and
treating the final coagulated water with a separation membrane of which the surface zeta potential is less than 0 mV, to obtain treated water.

2. The water treatment method according to claim 1, wherein a concentration Cop1 of the cationic coagulant to be dosed in the primary coagulated water is set to a value that is larger than Cmin and smaller than Cmax, Cmin and Cmax which are each determined and defined as follows:
Cmin: Concentration of a cationic coagulant in the primary coagulated water capable of obtaining the maximum coagulation effect when the water quality index of raw water is the lowest; and
Cmax: Concentration of a cationic coagulant in the primary coagulated water capable of obtaining the maximum coagulation effect when the water quality index of raw water is the highest.

3. The water treatment method according to claim 2, wherein a water quality index of raw water is at least one selected from the group consisting of a turbidity, a fine particle concentration, a total suspended solid (TSS) concentration, a total organic carbon (TOC) concentration, a dissolved organic carbon (DOC) concentration, a chemical oxygen demand (COD), a biological oxygen demand (BOD), and a ultraviolet ray adsorption (UVA) amount.

4. The water treatment method according to claim 1, wherein an dosing concentration Cop1 of an anionic substance is determined in advance so that the zeta potential is to be less than 0 mV by dosing to water in which the cationic coagulant is dosed to pure water so that the concentration is to be a difference (Cmax−Cmin), and the anionic substance is dosed to the primary coagulated water so that the concentration in the primary coagulated water is Cop1.

5. The water treatment method according to claim 1, wherein the cationic coagulant is an inorganic coagulant and the anionic substance is an organic coagulant.

6. The water treatment method according to claim 1, wherein the water treated with the separation membrane is desalinated with a semipermeable membrane having a surface zeta potential less than 0 mV.
